(19) United States
(12) Patent Application Publication
(10) Pub. No.: US 2026/0205023 A1
(43) Pub. Date: Jul. 16, 2026

(54) MULTI-TRANSFORMER DCDC CIRCUIT, AND CURRENT EQUALIZATION SYSTEM

(71) Applicant: AcePower and Technologies Co.,Ltd, Shanghai (CN)

(72) Inventor: Chao YAN, Shanghai City (CN)

(21) Appl. No.: 19/138,041

(22) PCT Filed: Nov. 2, 2023
(86) PCT No.: PCT/CN2023/129438

§ 371 Date: Jun. 11, 2025

(30) Foreign Application Priority Data
Dec. 16, 2022 (CN) 202211625812.6

(51) Int. Cl. H02M 3/335; H02M 1/00; H02M 1/02; H02M 3/00

(52) U.S. Cl. CPC H02M 3/33592; H02M 1/0064; H02M 1/0074; H02M 1/02; H02M 3/01

(57) ABSTRACT

A multi-transformer DCDC circuit and a current equalization system, which relates to the fields of electronics and electric power techniques is provided. The circuit includes two LLC circuits, each LLC circuit including a primary circuit, a secondary circuit and m transformers, each of the transformers including two primary windings and a secondary winding; wherein a first primary winding of an i-th transformer of the first LLC circuit is connected in series with a first primary winding of an i-th transformer of the second LLC circuit and then connected to a corresponding primary circuit, a second primary winding of the i-th transformer of the first LLC circuit is connected in series with a second primary winding of an i-th transformer of the second LLC circuit and then connected to a corresponding primary circuit, and secondary windings of the transformers are connected to corresponding secondary circuits.

### TECHNICAL FIELD

This disclosure relates to the fields of electronics and electric power techniques, and in particular to a multi-transformer DCDC circuit and a current equalization system.

### BACKGROUND

In recent years, electric vehicles have shown promising prospects due to their relatively small environmental impact compared to traditional vehicles. As electric vehicles are powered by onboard power supplies and batteries have less energy storage per unit weight, consumers need to charge them frequently, so as to ensure normal use of electric vehicles.

### SUMMARY

It was found by the inventors that current charging techniques are gradually unable to meet requirements of consumers for charging speeds of electric vehicles.

Faster charging speed means higher charging power, hence, the market is increasingly demanding higher power from charging modules in charging stations. Series parallel structures of circuit topology are commonly used in existing circuit designs to meet higher power requirements. For example, FIG. 1A shows a parallel topology structure of a conventional two-path LLC full bridge circuit. As there exit tolerances of such LLC parameters as inductors and resonant capacitors, in order to achieve current sharing in the operations of these two LLC circuits, it is needed to independently detect respective output currents of the two-path LLC, so as to independently control switching frequencies of the two-path LLC. However, in this mode, the switching frequencies of the two-path LLC will be inconsistent.

For example, FIG. 1B shows a conventional topology structure of two-path LLC with primary series and secondary parallel. In a coupling mode of primary series, two LLC full bridge circuits are controlled to be at the same operating frequency. As the primary is connected in series, DC currents of the primary is consistent. However, as differences may possibly exist in resonance parameters in the two LLC circuits, only basic power equalization, i.e. current basic equalization, can be achieved for the two LLC full bridge circuits.

In order to solve at least one of the above problems, this disclosure provide a multi-transformer DCDC circuit, including two LLC circuits, each LLC circuit including a primary circuit, a secondary circuit and m transformers,
each of the transformers including two primary windings and a secondary winding arranged between the two primary windings;
wherein the two LLC circuits includes a first LLC circuit and a second LLC circuit, a first primary winding of an i-th transformer of the first LLC circuit being connected in series with a first primary winding of an i-th transformer of the second LLC circuit and then connected to a corresponding primary circuit, a second primary winding of the i-th transformer of the first LLC circuit being connected in series with a second primary winding of an i-th transformer of the second LLC circuit and then connected to a corresponding primary circuit, and the secondary windings of the transformers are connected to corresponding secondary circuits; where, 1≤i≤m, and both i and m are positive integers.

In some embodiments, the primary circuit includes a full-bridge circuit, and a value of m is 1;
wherein the primary circuit of the first LLC circuit includes a first switching tube, a second switching tube, a third switching tube and a fourth switching tube, the first switching tube and the second switching tube being connected in series and then connected in parallel with the third switching tube and the fourth switching tube that are connected in series, the primary circuit of the second LLC circuit includes a fifth switching tube, a sixth switching tube, a seventh switching tube and an eighth switching tube, the fifth switching tube and the sixth switching tube being connected in series and then connected in parallel with the seventh switching tube and the eighth switching tube that are connected in series;
a first primary winding of a transformer of the first LLC circuit is connected in series with a set of resonant capacitors and resonant inductors and then connected between the first switching tube and the second switching tube, and a first primary winding of a transformer of the second LLC circuit is connected between the third switching tube and the fourth switching tube;
a second primary winding of the transformer of the first LLC circuit is connected between the seventh switching tube and the eighth switching tube, and a second primary winding of the transformer of the second LLC circuit is connected in series with a set of resonant capacitors and resonant inductors and then connected between the fifth switching tube and sixth switching tube.

In some embodiments, the secondary circuit includes a full wave rectifier circuit;
the secondary circuit of the first LLC circuit includes a first diode, a second diode, a third diode and a fourth diode, the first diode and the second diode being connected in series and then connected in parallel with the third diode and the fourth diode that are connected in series, the secondary circuit of the second LLC circuit includes a fifth diode, a sixth diode, a seventh diode and an eighth diode, the fifth diode and the sixth diode being connected in series and then connected in parallel with the seventh diode and the eighth that are connected in series;
one end of the secondary winding of the transformer of the first LLC circuit is connected between the first diode and the second diode, and the other end thereof is connected between the third diode and the fourth diode;
one end of the secondary winding of the transformer of the second LLC circuit is connected between the fifth diode and the sixth diode, and the other end thereof is connected between the seventh diode and the eighth diode.

In some embodiments, the secondary circuit includes a synchronous rectifier circuit;
the secondary circuit of the first LLC circuit includes a ninth switching tube, a tenth switching tube, an eleventh switching tube and a twelfth switching tube, the ninth switching tube and the tenth switching tube being connected in series and then connected in parallel with the eleventh switching tube and the twelfth switching tube that are connected in series, the secondary circuit of the second LLC circuit includes a thirteenth switching tube, a fourteenth switching tube, a fifteenth switching tube and a sixteenth switching tube, the thirteenth switching tube and the fourteenth switching tube being connected in series and then connected in parallel with the fifteenth switching tube and the sixteenth switching tube that are connected in series;
one end of the secondary winding of the transformer of the first LLC circuit is connected between the ninth switching tube and the tenth switching tube, and the other end thereof is connected between the eleventh switching tube and the twelfth switching tube;
one end of the secondary winding of the transformer of the second LLC circuit is connected between the thirteenth switching tube and the fourteenth switching tube, and the other end thereof is connected between the fifteenth switching tube and the sixteenth switching tube.

In some embodiments, the primary circuit includes a three-phase bridge circuit, and a value of m is 3;
wherein the primary circuit of the first LLC circuit includes a first switching tube, a second switching tube, a third switching tube, a fourth switching tube, a fifth switching tube and a sixth switching tube, the first switching tube and the second switching tube being connected in series and then respectively connected in parallel with the third switching tube and the fourth switching tube that are connected in series and the fifth switching tube and the sixth switching tube that are connected in series; the primary circuit of the second LLC circuit includes a seventh switching tube, an eighth switching tube, a ninth switching tube, a tenth switching tube, an eleventh switching tube and a twelfth switching tube, the seventh switching tube and the eighth switching tube being connected in series and then respectively connected in parallel with the ninth switching tube and the tenth switching tube that are connected in series and the eleventh switching tube and the twelfth switching tube that are connected in series;
the second primary winding of the first transformer of the first LLC circuit is connected between the first switching tube and the second switching tube, the first primary winding of the first transformer of the second LLC circuit is connected between the seventh switching tube and the eighth switching tube, and the first primary winding of the first transformer of the first LLC circuit is connected in series with a set of resonant capacitors and resonant inductors, and then connected to the second primary winding of the first transformer of the second LLC circuit via another set of resonant capacitors and resonant inductors;
a second primary winding of a second transformer of the first LLC circuit is connected between the third switching tube and the fourth switching tube, a first primary winding of the second transformer of the second LLC circuit is connected between the ninth switching tube and the tenth switching tube, and the first primary winding of the second transformer of the first LLC circuit is connected in series with a set of resonant capacitors and resonant inductors, and then connected to the second primary winding of the second transformer of the second LLC circuit via another set of resonant capacitors and resonant inductors;
a second primary winding of a third transformer of the first LLC circuit is connected between the fifth switching tube and sixth switching tube, a first primary winding of the third transformer of the second LLC circuit is connected between the eleventh switching tube and the twelfth switching tube, and the first primary winding of the third transformer of the first LLC circuit is connected in series with a set of resonant capacitors and resonant inductors, and then connected to the second primary winding of the third transformer of the second LLC circuit via another set of resonant capacitors and resonant inductors.

In some embodiments, the secondary circuit includes a full wave rectifier circuit;
the secondary circuit of the first LLC circuit includes a first diode, a second diode, a third diode, a fourth diode, a fifth diode and a sixth diode, the first diode and the second diode being connected in series and then respective connected in parallel with the third diode and the fourth diode that are connected in series and the fifth diode and the sixth diode that are connected in series, the secondary circuit of the second LLC circuit includes a seven diode, an eighth diode, a ninth diode, a tenth diode, an eleventh diode and a twelfth diode, the seven diode and the eighth diode being connected in series and then respective connected in parallel with the ninth diode and the tenth diode that are connected in series and the eleventh diode and the twelfth diode that are connected in series;
a first end of the secondary winding of the first transformer of the first LLC circuit is connected between the first diode and the second diode, a first end of the secondary winding of the second transformer of the first LLC circuit is connected between the third diode and the fourth diode, a first end of the secondary winding of the third transformer of the first LLC circuit is connected between the fifth diode and the sixth diode, a second end of the secondary winding of the first transformer of the first LLC circuit is connected to a second end of the secondary winding of the second transformer of the first LLC circuit and a second end of the secondary winding of the third transformer of the first LLC circuit;
a first end of the secondary winding of the first transformer of the second LLC circuit is connected between the seventh diode and the eighth diode, a first end of the secondary winding of the second transformer of the second LLC circuit is connected between the ninth diode and the tenth diode, a first end of the secondary winding of the third transformer of the second LLC circuit is connected between the eleventh diode and the twelfth diode, a second end of the secondary winding of the first transformer of the second LLC circuit is connected to a second end of the secondary winding of the second transformer of the second LLC circuit and a second end of the secondary winding of the third transformer of the second LLC circuit.

In some embodiments, the secondary circuit includes a synchronous rectifier circuit;
the secondary circuit of the first LLC circuit includes a thirteenth switching tube, a fourteenth switching tube, a fifteenth switching tube, a sixteenth switching tube, a seventeenth switching tube and an eighteenth switching tube, the thirteenth switching tube and the fourteenth switching tube being connected in series and then respectively connected in parallel with the fifteenth switching tube and the sixteenth switching tube that are connected in series and the seventeenth switching tube and the eighteenth switching tube that are connected in series, and the secondary circuit of the second LLC circuit includes a nineteenth switching tube, a twentieth switching tube, a twenty-first switching tube, a twenty-second switching tube, a twenty-third switching tube and a twenty fourth switching tube, the nineteenth switching tube and the twentieth switching tube being connected in series and then respectively connected in parallel with the twenty-first switching tube and the twenty-second switching tube that are connected in series and the twenty-third switching tube and the twenty-fourth switching tube that are connected in series;
the first end of the secondary winding of the first transformer of the first LLC circuit is connected between the thirteenth switching tube and fourteenth switching tube, the first end of the secondary winding of the second transformer of the first LLC circuit is connected between the fifteenth switching tube and sixteenth switching tube, the first end of the secondary winding of the third transformer of the first LLC circuit is connected between the seventeenth switching tube and eighteenth switching tube, the second end of the secondary winding of the first transformer of the first LLC circuit is connected to the second end of the secondary winding of the second transformer of the first LLC circuit and the second end of the secondary winding of the third transformer of the first LLC circuit;
the first end of the secondary winding of the first transformer of the second LLC circuit is connected between the nineteenth switching tube and the twentieth switching tube, the first end of the secondary winding of the second transformer of the second LLC circuit is connected between the twenty-first switching tube and the twenty-second switching tube, the first end of the secondary winding of the third transformer of the second LLC circuit is connected between the twenty-third switching tube and twenty-fourth switching tube, and the second end of the secondary winding of the first transformer of the second LLC circuit is connected to the second end of the secondary winding of the second transformer of the second LLC circuit and the second end of the secondary winding of the third transformer of the second LLC circuit.

In some embodiments, any resonant inductor in the multi-transformer DCDC circuit is integrated into leakage inductance of a transformer to which the resonant inductor corresponds.

In some embodiments, the primary circuit of the first LLC circuit is connected in parallel with the primary circuit of the second LLC circuit.

In some embodiments, the primary circuit of the first LLC circuit is connected in series with the primary circuit of the second LLC circuit.

In some embodiments, this disclosure further provides a current equalization system, the current equalization system using any multi-transformer DCDC provided in this disclosure.

With very simple synchronization control techniques, on the premise of realizing the function of power parallel, power equalization, i.e. natural current equalization, between two power units, is simultaneously realized in the multi-transformer DCDC circuit and the current equalization system in this disclosure naturally, control schemes are simplified, and reliabilities of circuits are improved.

### BRIEF DESCRIPTION OF THE DRAWINGS

In order to provide clearer explanations of the embodiments of this disclosure or technical solutions in the related art, a brief introduction will be given to accompanying drawings required for description of the embodiments or the related art. Obviously, the accompanying drawings described below are only some embodiments of this disclosure. For those skilled in the art, other drawings may be obtained according to these drawings without making an inventive effort. In the drawings:

FIGS. 1A and 1B are topology structures of LLC circuits in the related art;

FIGS. 2A and 2B are schematic diagrams of structures of transformer provided in this disclosure;

FIGS. 3A and 3B are connection relationships between primary windings and secondary windings of the transformers provided in this disclosure;

FIG. 4A is a schematic diagram of the primary circuit and a connection relationship between it and a transformer provided in this disclosure;

FIG. 4B is a schematic diagram of driving pulses of switching tubes in the primary circuit shown in FIG. 4A;

FIG. 4C is a schematic diagram of the secondary circuit and a connection relationship between it and a transformer provided in this disclosure;

FIG. 4D is another schematic diagram of the secondary circuit and the connection relationship between it and a transformer provided in this disclosure;

FIG. 5A is another schematic diagram of the primary circuit and the connection relationship between it and a transformer provided in this disclosure;

FIG. 5B is a schematic diagram of driving pulses of switching tubes in the primary circuit shown in FIG. 5A;

FIG. 5C is another schematic diagram of the secondary circuit and the connection relationship between it and a transformer provided in this disclosure;

FIG. 5D is a further schematic diagram of the secondary circuit and the connection relationship between it and a transformer provided in this disclosure;

FIG. 6A is a topological graph of the circuit shown in FIG. 4C after leakage inductance integration;

FIG. 6B is a topological graph of the circuit shown in FIG. 4D after leakage inductance integration;

FIG. 6C is a topological graph of the circuit shown in FIG. 5C after leakage inductance integration; and

FIG. 6D is a topological graph of the circuit shown in FIG. 5D after leakage inductance integration.

### DETAILED DESCRIPTION

In order to make the purpose, technical solutions and advantages of the embodiments of this disclosure more clear, the embodiments of this disclosure shall be described below with reference to the accompanying drawings. Here, illustrative embodiments of this disclosure and their explanations are used to explain this disclosure, and are not intended to limit this disclosure.

It should be noted that the multi-transformer DCDC circuit of this disclosure may be applicable to the fields of electronic and electrical power techniques, and may also be applicable to other fields than the fields of electronic and electrical power techniques. Application fields of the multi-transformer DCDC circuit are not limited in this disclosure.

This disclosure provides a multi-transformer DCDC circuit, including two LLC circuits, each LLC circuit including a primary circuit, a secondary circuit and m transformers.

In particular, referring to FIGS. 2A-2B for structures of the transformers, each of the transformers includes a primary winding P₁, a primary winding P₂ and a secondary winding S₁, wherein the secondary winding S₁ is arranged between the primary winding P₁ and the primary winding P₂. FIG. 2A is a sectional view of a transformer. The primary winding P₁, the secondary winding S₁ and the primary winding P₂ are sequentially wound around a frame F from the left to the right. One of features of the transformer shown in FIGS. 2A and 2B is that the two primary windings of the transformer is relatively far from each other, and a coupling coefficient thereof is relatively low, which is generally not higher than 0.95, that is, the coupling coefficient of the two primary windings of the transformer adopted in this disclosure is less than or equal to 0.95. Here, the coupling coefficient is defined as follows:

$$k = \sqrt{1 - \frac{{L}_{sc}}{{L}_{open}}} ;$$

where, k is the coupling coefficient of the primary winding P₁ and the primary winding P₂, L_{sc} is leakage inductance at a side of the primary winding P₁ measured when the primary winding P₂ is short-circuited, and Lₒₚₑₙ is inductance at the side of the primary winding P₁ measured when the primary winding P₂ is open-circuited.

A connection mode of the primary windings and secondary windings of the transformers in the two LLC circuits is as follows: a first primary winding of an i-th transformer of the first LLC circuit is connected in series with a first primary winding of an i-th transformer of the second LLC circuit and then connected to a corresponding primary circuit, a second primary winding of the i-th transformer of the first LLC circuit is connected in series with a second primary winding of an i-th transformer of the second LLC circuit and then connected to a corresponding primary circuit, and the secondary windings of the transformers are connected to corresponding secondary circuits; where, 1≤i≤m, and both i and m are positive integers. The number m of the transformers in each LLC circuit may be greater than or equal to 1 and taken from 1, 2, 3, 4, 5, 6, 7, 8, 9, 10, 11, and 13, etc., which is illustrative only, and is not limited here.

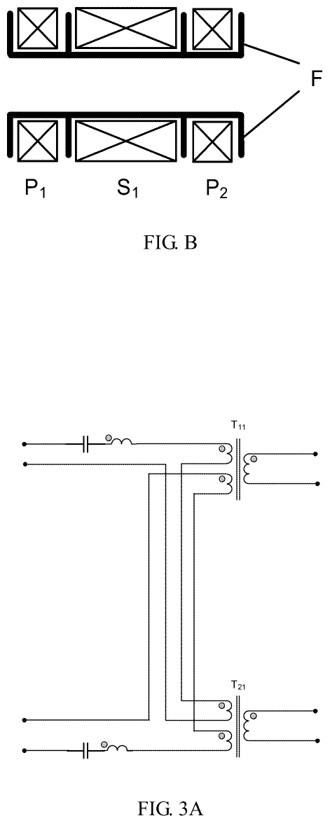

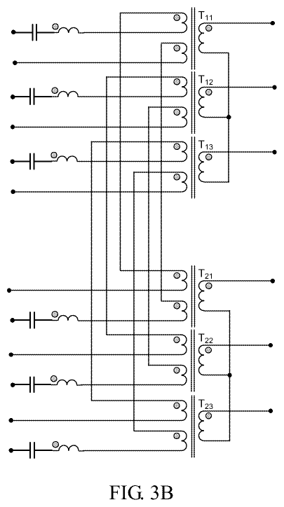

For example, FIG. 3A shows a connection relationship when it is assumed that each LLC circuit includes one transformer, wherein the first LLC circuit includes a transformer T₁₁, and the second LLC circuit includes a transformer T₂₁. FIG. 3B shows a connection relationship when it is assumed that each LLC circuit includes three transformers, wherein the first LLC circuit includes three transformers, T₁₁, T₁₂ and T₁₃, and the second LLC circuit includes three transformers, T₂₁, T₂₂ and T₂₃.

A connection mode of the primary circuits in the two LLC circuits may be as follows: the primary circuit of the first LLC circuit is connected in parallel with the primary circuit of the second LLC circuit, or the primary circuit of the first LLC circuit is connected in series with a DC input of the primary circuit of the second LLC circuit. When the parallel connection mode of the primary circuits is used, input voltages of the primary circuits may reach 650V-800V, but currents of each primary circuit may be reduced by half in comparison with those in the DC input series connection mode of the primary circuits, which is conducive to protecting electronic components in the LLC circuits, avoiding damages to the electronic components caused by overcurrents, and achieving relatively high efficiencies. However, both parallel connection of the primary circuits and the DC input series connection of the primary circuit are applicable to this disclosure, and natural current equalization and synchronous control of two LLC circuits may be achieved.

A connection mode of the secondary circuits in the two LLC circuits may be in consistence with the connection mode of the primary circuits, that is, when the primary circuits of the two LLC circuits are connected in parallel, the secondary circuits of the two LLC circuits are DC output connected in parallel; and when the primary circuits of the two LLC circuits are DC input connected in series, the secondary circuits of the two LLC circuits are DC output connected in series.

Connection relationships between the transformers and primary circuits and secondary circuits in the LLC circuits varies depending on types of the primary circuits and secondary circuits, and shall comply with circuit characteristics of the primary circuits and secondary circuits. Some specific examples are given in this disclosure for illustration. In the following examples, description shall be given by taking the connection mode where the primary circuits of the two LLC circuits are connected in parallel and the secondary circuits thereof are connected in parallel as an example; however, this disclosure is not limited thereto. Meanwhile, for ease of expression, it is collectively defined that the primary circuit of the first LLC circuit is A₁, the secondary circuit thereof is B₁, and the transformers thereof are T₁₁, T₁₂, T₁₃ . . . T₁ₘ, and the primary circuit of the second LLC circuit is A₂, the secondary circuit thereof is B₂, and the transformers thereof are T₂₁, T₂₂, T₂₃ . . . T₂ₘ; where, m is the number of transformers contained in each LLC circuit, which is a positive integer. The above definitions are applicable to all of the following examples.

### Example 1: The Primary Circuit Includes a Full Bridge Circuit

At this time, in order to comply with circuit characteristics of the full bridge circuit, each LLC circuit needs to include a transformer, that is, a value of m is 1.

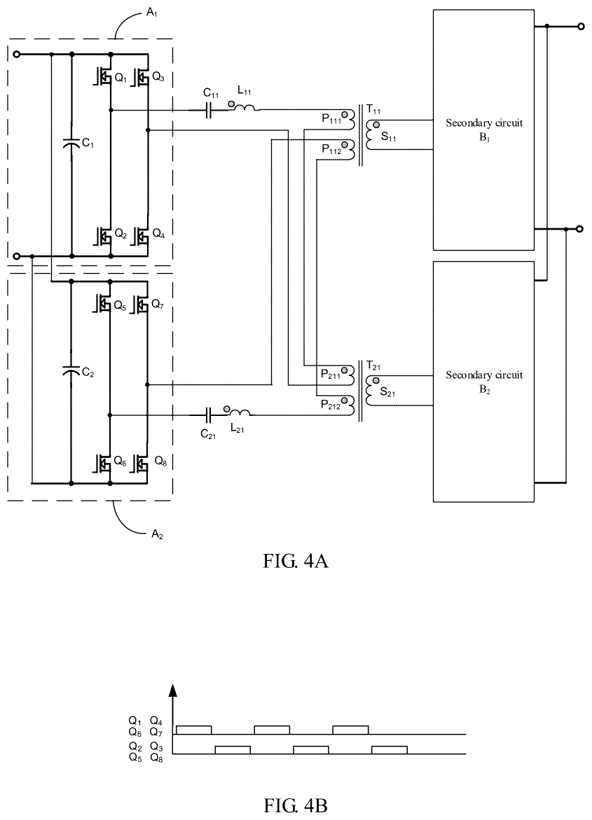

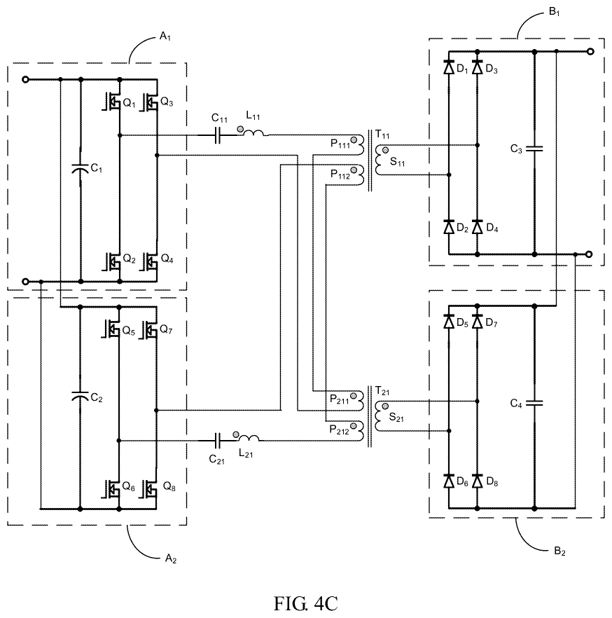

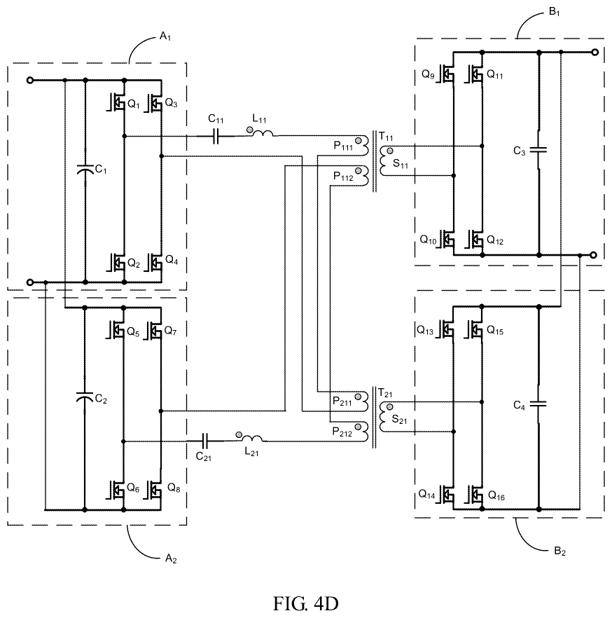

FIG. 4A shows a circuit topology in which two full bridge LLC circuits are connected in parallel, wherein the primary circuit A₁ includes three parallelly connected circuits, a first parallelly connected circuit including a capacitor C₁, a second parallelly connected circuit including a first switching tube Q₁ and a second switching tube Q₂ connected in series, and a third parallelly connected circuit including a third switching tube Q₃ and a fourth switching tube Q₄ connected in series. A structure of the primary circuit A₂ is similar to that of the primary circuit A₁, which also includes three parallelly connected circuits, a first parallelly connected circuit including a capacitor C₂, a second parallelly connected circuit including a fifth switching tube Q₅ and a sixth switching tube Q₆ connected in series, and a third parallelly connected circuit including a seventh switching tube Q₇ and an eighth switching tube Q₈ connected in series.

One end of a first primary winding Pin of the transformer T₁₁ is connected in series with one end of a first primary winding P₂₁₁ of the transformer T₂₁, and the other end thereof is connected in series with a set of resonant capacitors C₁₁ and resonant inductors L₁₁ and then connected between the first switching tube Q₁ and the second switching tube Q₂, and the other end of the first primary winding P₂₁₁ of the transformer T₂₁ is connected between the third switching tube Q₃ and the fourth switching tube Q₄.

Likewise, one end of a second primary winding P₁₁₂ of the transformer T₁₁ is connected in series with one end of a second primary winding P₂₁₂ of the transformer T₂₁, and the other end thereof is connected between the seventh switching tube Q₇ and the eighth switching tube Q₈, and the other end of the second primary winding P₂₁₂ of the transformer T₂₁ is connected in series with a set of resonant capacitors C₂₁ and resonant inductors L₂₁ and then connected between the fifth switching tube Q₅ and the sixth switching tube Q₆.

FIG. 4B is a schematic diagram of driving pulses of switching tubes in the primary circuit shown in FIG. 4A. It can be seen from FIG. 4B that the first switching tube Q₁, the fourth switching tube Q₄, the sixth switching tube Q₆ and the seventh switching tube Q₇ are concurrently switched on, and the second switching tube Q₂, the third switching tube Q₃, the fifth switching tube Q₅ and the eighth switching tube Q₈ are concurrently switched on.

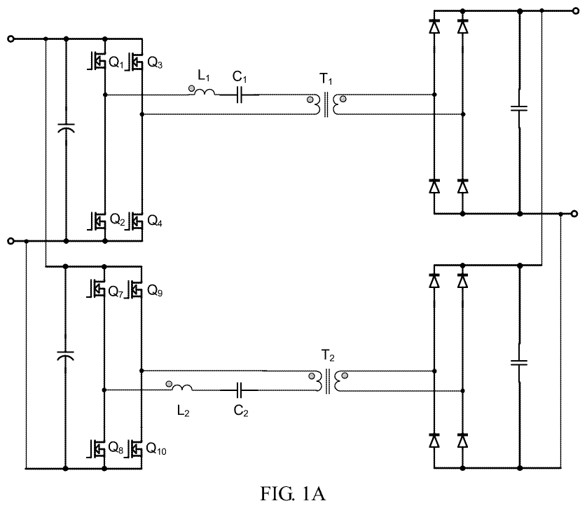

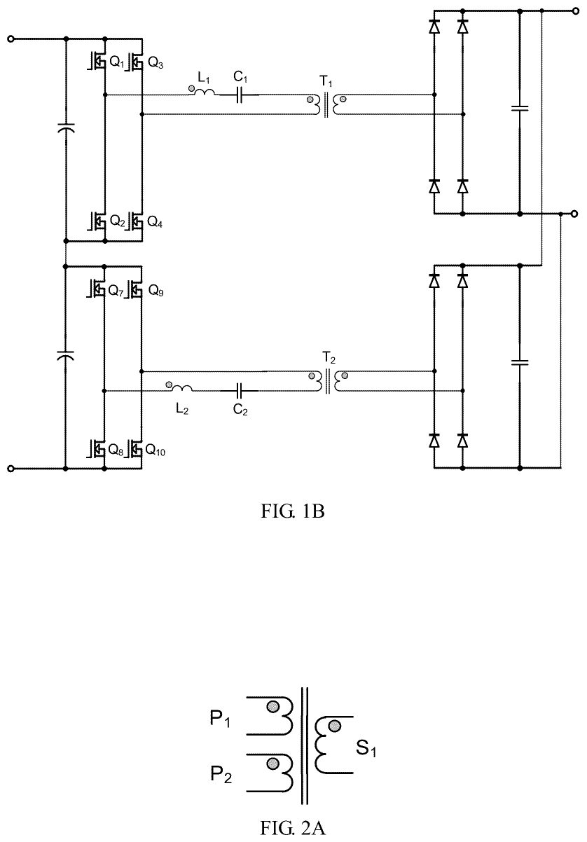

With the series coupling of the transformer with two primary windings between upper and lower full bridges as shown in Example 1, natural two full bridge LLC current equalization may be achieved, and the two full bridge circuits have consistent control frequencies. In normal operating conditions (excluding such special states as a starting state), control signals of the first switching tube Q₁, the fourth switching tube Q₄, the sixth switching tube Q₆ and the seventh switching tube Q₇ are consistent, and control signals of the second switching tube Q₂, the third switching tube Q₃, the fifth switching tube Q₅ and the eighth switching tube Q₈ are consistent. At the same time, complementation of the two control signals plus a certain dead time (the dead time is preset) will greatly simplify control lines and control algorithms, and may also avoid output of ripple currents and ripple voltages caused by a beat frequency (i.e. a frequency difference between two paths, which may vary over time) brought about by the asynchronous control mode of the circuit topology shown in FIG. 1A.

When the primary circuit is as shown in Example 1, the secondary circuit may refer to Example 2 and Example 3.

### Example 2: The Secondary Circuit Includes a Full Wave Rectifier Circuit Composed of Diodes

As shown in FIG. 4C, the secondary circuit B₁ includes three parallelly connected circuits, a first parallelly connected circuit including a capacitor C₃, a second parallelly connected circuit including a first diode D₁ and a second diode D₂ connected in series, and a third parallelly connected circuit including a third diode D₃ and a fourth diode D₄ connected in series. The secondary circuit B₂ has a structure similar to that of the secondary circuit B₁, which also includes three parallelly connected circuits, a first parallelly connected circuit including a capacitor C₄, a second parallelly connected circuit including a fifth diode D₅ and a sixth diode D₆ connected in series, and a third parallelly connected circuit including seventh diode D₇ and eighth diode D₈ connected in series.

One end of the secondary winding Su of the transformer T₁₁ is connected between the first diode D₁ and the second diode D₂, and the other end thereof is connected between the third diode D₃ and the fourth diode D₄.

Likewise, one end of the secondary winding S₂₁ of the transformer T₂₁ is connected between the fifth diode D₅ and the sixth diode D₆, and the other end thereof is connected between the seventh diode D₇ and the eighth diode D₈.

### Example 3: The Secondary Circuit Includes a Synchronous Rectifier Circuit Composed of Switching Tubes

As shown in FIG. 4D, the secondary circuit B₁ includes three parallelly connected circuits, a first parallelly connected circuit including a capacitor C₃, a second parallelly connected circuit including a ninth switching tube Q₉ and a tenth switching tube Q₁₀ connected in series, and a third parallelly connected circuit including an eleventh switching tube Q₁₁ and a twelfth switching tube Q₁₂ connected in series. The secondary circuit B₂ has a structure similar to that of the secondary circuit B₁, which also includes three parallelly connected circuits, a first parallelly connected circuit including a capacitor C₄, a second parallelly connected circuit including a thirteenth switching tube Q₁₃ and a fourteenth switching tube Q₁₄ connected in series, and a third parallelly connected circuit including a fifteenth switching tube Q₁₅ and a sixteenth switching tube Q₁₆ connected in series.

One end of the secondary winding Su of the transformer T₁₁ is connected between the ninth switching tube Q₉ and the tenth switching tube Q₁₀, and the other end thereof is connected between the eleventh switching tube Q₁₁ and the twelfth switching tube Q₁₂.

Likewise, one end of the secondary winding S₂₁ of the transformer T₂₁ is connected between the thirteenth switching tube Q₁₃ and the fourteenth switching tube Q₁₄, and the other end thereof is connected between the fifteenth switching tube Q₁₅ and the sixteenth switching tube Q₁₆.

### Example 4: The Primary Circuit Includes a Three-Phase Bridge Circuit

At this time, in order to comply with circuit characteristics of the three-phase bridge circuit, each LLC circuit needs to include three transformers, that is, a value of m is 3, a first LLC circuit including transformers T₁₁, T₁₂ and T₁₃, and the second LLC circuit including transformers T₂₁, T₂₂ and T₂₃.

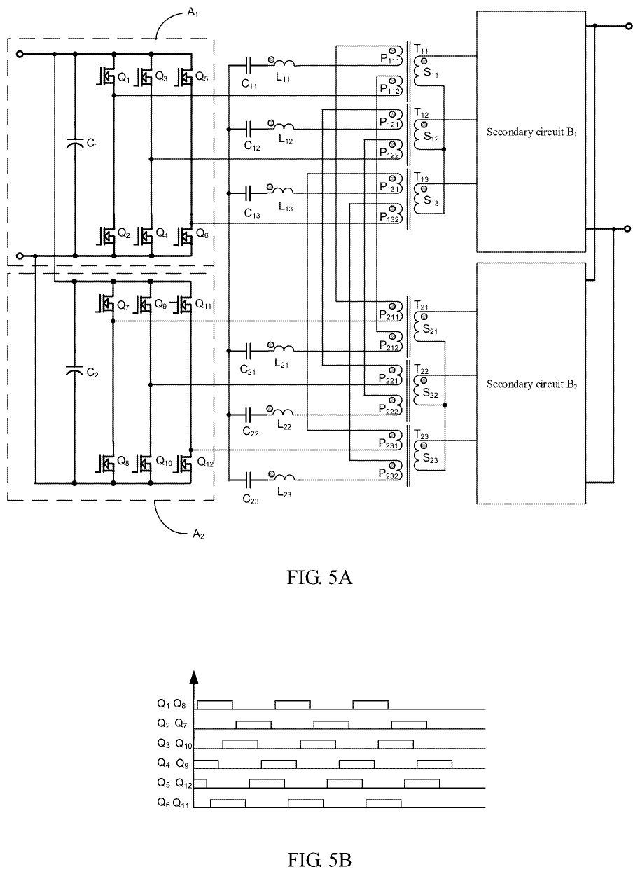

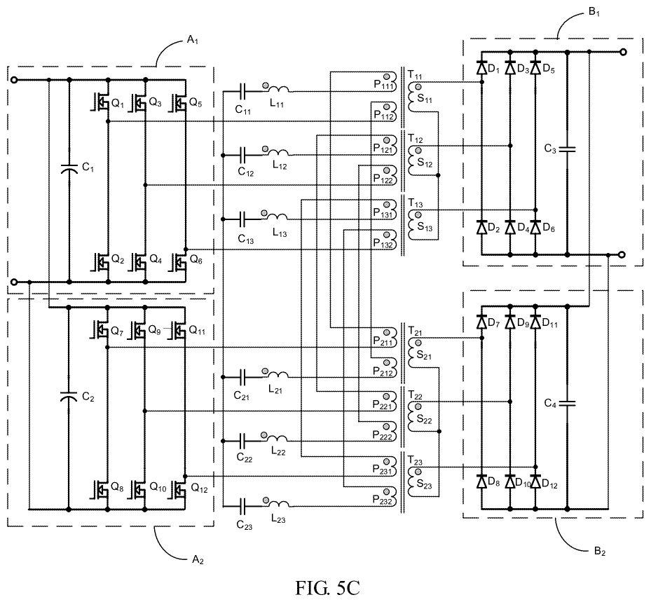

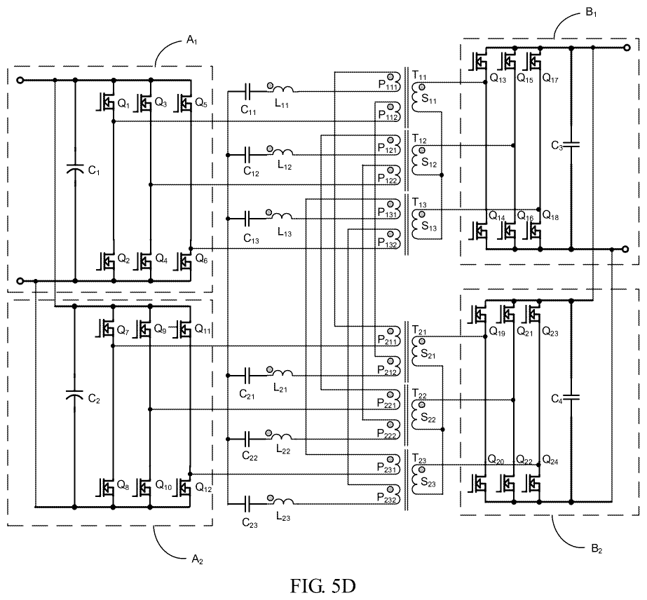

FIG. 5A shows a circuit topology in which two three-bridge LLC circuits are connected in parallel, wherein the primary circuit A₁ includes four parallelly connected circuits, a first parallelly connected circuit including a capacitor C₁, a second parallelly connected circuit including a first switching tube Q₁ and second switching tube Q₂ connected in series, a third parallelly connected circuit including a third switching tube Q₃ and fourth switching tube Q₄ connected in series, and a fourth parallelly connected circuit including a fifth switching tube Q₅ and sixth switching tube Q₆ connected in series. The primary circuit A₂ has a structure similar to that of the primary circuit A₁, which also includes four parallelly connected circuits, a first parallelly connected circuit including a capacitor C₂, a second parallelly connected circuit including a seventh switching tube Q₇ and eighth switching tube Q₈ connected in series, a third parallelly connected circuit including a ninth switching tube Q₃ and tenth switching tube Q₁₀ connected in series, and a fourth parallelly connected circuit including an eleventh switching tube Q₁₁ and twelfth switching tube Q₁₂ connected in series.

One end of the second primary winding P₁₁₂ of the transformer T₁₁ is connected between the first switching tube Q₁ and the second switching tube Q₂, and the other end thereof is connected to one end of the second primary winding P₂₁₂ of the transformer T₂₁, the other end of the primary winding P₂₁₂ is connected in series with a set of resonant capacitors C₂₁ and resonant inductors L₂₁ and then connected to a common node. One end of the first primary winding P₂₁₁ of the transformer T₂₁ is connected to the seventh switching tube Q₇ and the eighth switching tube Q₈, and the other end thereof is connected to one end of the first primary winding P₁₁₁ of the transformer T₁₁, the other end of the primary winding Pin is connected in series with a set of resonant capacitors C₁₁ and resonant inductors L₁₁ and then connected to a common node, so as to connect with the primary winding P₂₁₂.

Likewise, one end of the second primary winding P₁₂₂ of the transformer T₁₂ is connected between the third switching tube Q₃ and the fourth switching tube Q₄, and the other end thereof is connected to one end of the second primary winding P₂₂₂ of the transformer T₂₂, the other end of the primary winding P₂₂₂ is connected in series with a set of resonant capacitors C₂₂ and resonant inductors L₂₂ and then connected to a common node. One end of the first primary winding P₂₂₁ of the transformer T₂₂ is connected to the ninth switching tube Q₉ and the tenth switching tube Q₁₀, and the other end thereof is connected to one end of the first primary winding P₁₂₁ of the transformer T₁₂, the other end of the primary winding P₁₂₁ is connected in series with a set of resonant capacitors C₁₂ and resonant inductors L₁₂ and then connected to a common node, so as to connect with the primary winding P₂₂₂.

One end of a second primary winding P₁₃₂ of the transformer T₁₃ is connected between the fifth switching tube Q₅ and the sixth switching tube Q₆, and the other end thereof is connected to one end of a second primary winding P₂₃₂ of the transformer T₂₃, the other end of the primary winding P₂₃₂ is connected in series with a set of resonant capacitors C₂₃ and resonant inductors L₂₃ and then connected to a common node. One end of the first primary winding P₂₃₁ of the transformer T₂₃ is connected to the eleventh switching tube Q₁₁ and the twelfth switching tube Q₁₂, and the other end thereof is connected to one end of a first primary winding P₁₃₁ of the transformer T₁₃, the other end of the primary winding P₁₃₁ is connected in series with a set of resonant capacitors C₁₃ and resonant inductors L₁₃ and then connected to a common node, so as to connect with the primary winding P₂₃₂.

FIG. 5B is a schematic diagram of driving pulses of the switching tubes in the primary circuit shown in FIG. 5A. It can be seen from FIG. 5B that the primary circuit may be controlled by three driving signals with a phase difference of 120° therebetween, wherein in the primary circuit, the first switching tube Q₁ and the eighth switching tube Q₈ conduct simultaneously, the second switching tube Q₂ and the seventh switching tube Q₇ conduct simultaneously, the third switching tube Q₃ and the tenth switching tube Q₁₀ conduct simultaneously, the fourth switching tube Q₄ and the ninth switching tube Q₉ conduct simultaneously, the fifth switching tube Q₅ and the twelfth switching tube Q₁₂ conduct simultaneously, and the sixth switching tube Q₆ and the eleventh switching tube Q₁₁ conduct simultaneously.

When the primary circuit is as shown in Example 4, the secondary circuit may be as shown in examples 5 and 6.

### Example 5: The Secondary Circuit Includes a Full Wave Rectifier Circuit Composed of Diodes

As shown in FIG. 5C, the secondary circuit B₁ includes four parallelly connected circuits, a first parallelly connected circuit including a capacitor C₃, a second parallelly connected circuit including a first diode D₁ and second diode D₂ connected in series, a third parallelly connected circuit including a third diode D₃ and fourth diode D₄ connected in series, and a fourth parallelly connected circuit including a fifth diode D₅ and sixth diode D₆ connected in series; and the secondary circuit B₂ has a structure similar to that of the secondary circuit B₁, which also includes four parallelly connected circuits, a first parallelly connected circuit including a capacitor C₄, a second parallelly connected circuit including a seventh diode D₇ and eighth diode D₈ connected in series, a third parallelly connected circuit including a ninth diode D₉ and tenth diode D₁₀ connected in series, and a fourth parallelly connected circuit including an eleventh diode D₁₁ and twelfth diode D₁₂ connected in series.

One end of the secondary winding S₁₁ of transformer T₁₁ is connected between the first diode D₁ and the second diode D₂, and the other end thereof is connected to a first common node; one end of the secondary winding S₁₂ of transformer T₁₂ is connected between the third diode D₃ and the fourth diode D₄, and the other end thereof is connected to the first common node; and one end of the secondary winding S₁₃ of transformer T₁₃ is connected between the fifth diode D₅ and the sixth diode D₆, and the other end thereof is connected to the first common node, that is, one ends of the secondary winding S₁₁, the secondary winding S₁₂ and the secondary winding S₁₃ are all connected to the same common node to achieve mutual connectivity.

Likewise, one end of the secondary winding S₂₁ of transformer T₂₁ is connected between the seven diode D₇ and the eighth diode D₈, and the other end thereof is connected to a second common node; one end of the secondary winding S₂₂ of transformer T₂₂ is connected between the ninth diode D₉ and the tenth diode D₁₀, and the other end thereof is connected to the second common node; and one end of the secondary winding S₂₃ of transformer T₂₃ is connected between the eleventh diode D₁₁ and the twelfth diode D₁₂, and the other end thereof is connected to the second common node, that is, one ends of the secondary winding S₂₁, the secondary winding S₂₂ and the secondary winding S₂₃ are all connected to the same common node to achieve mutual connectivity.

It should be noted that the first common node and the second common node are different nodes.

### Example 6: The Secondary Circuit Includes a Synchronous Rectifier Circuit Composed of Switching Tubes

As shown in FIG. 5D, the secondary circuit B₁ includes four parallelly connected circuits, a first parallelly connected circuit including a capacitor C₃, a second parallelly connected circuit including a thirteenth switching tube Q₁₃ and a fourteenth switching tube Q₁₄ connected in series, a third parallelly connected circuit including a fifteenth switching tube Q₁₅ and a sixteenth switching tube Q₁₆ connected in series, and a fourth parallelly connected circuit including a seventeenth switching tube Q₁₇ and an eighteenth switching tube Q₁₈ connected in series; and the secondary circuit B₂ has a structure similar to that of the secondary circuit B₁, which also includes four parallelly connected circuits, a first parallelly connected circuit including a capacitor C₄, a second parallelly connected circuit including a nineteenth switching tube Q₁₉ and a twentieth switching tube Q₂₀ connected in series, a third parallelly connected circuit including a twenty-first switching tube Q₂₁ and a twenty-second switching tube Q₂₂ connected in series, and a fourth parallelly connected circuit including a twenty-third switching tube Q₂₃ and a twenty-fourth switching tube Q₂₄ connected in series.

One end of the secondary winding S₁₁ of transformer T₁₁ is connected between the thirteenth switching tube Q₁₃ and the fourteenth switching tube Q₁₄, and the other end thereof is connected to the first common node; one end of the secondary winding S₁₂ of transformer T₁₂ is connected between the fifteenth switching tube Q₁₅ and the sixteenth switching tube Q₁₆, and the other end thereof is connected to the first common node; and one end of the secondary winding S₁₃ of transformer T₁₃ is connected between the seventeenth switching tube Q₁₇ and the eighteenth switching tube Q₁₈, and the other end thereof is connected to the first common node, that is, one ends of the secondary winding S₁₁, the secondary winding S₁₂ and the secondary winding S₁₃ are all connected to the same common node to achieve mutual connectivity.

Likewise, one end of the secondary winding S₂₁ of transformer T₂₁ is connected between the nineteenth switching tube Q₁₉ and the twentieth switching tube Q₂₀, and the other end thereof is connected to the second common node; one end of the secondary winding S₂₂ of transformer T₂₂ is connected between the twenty-first switching tube Q₂₁ and the twenty-second switching tube Q₂₂, and the other end thereof is connected to the second common node; and one end of the secondary winding S₂₃ of transformer T₂₃ is connected between the twenty-third switching tube Q₂₃ and the twenty-fourth switching tube Q₂₄, and the other end thereof is connected to the second common node, that is, one ends of the secondary winding S₂₁, the secondary winding S₂₂ and the secondary winding S₂₃ are all connected to the same common node to achieve mutual connectivity.

It should be noted that the first common node and the second common node are different nodes.

The above examples 1-6 respectively illustrate connection relationships between various primary circuits and secondary circuits and their transformers, wherein compared to the full wave rectifier circuits in examples 2 and 5, the synchronous rectifier circuits in examples 3 and 6 achieve bidirectional operations of the circuits. In addition to the above examples, those skilled in the art may connect the structure in this disclosure in which the primary circuits of the transformers are coupled in series with other types of circuits according to the principles of this disclosure on the premise of satisfying the circuit characteristics; however, this disclosure is not limited thereto.

In some embodiment, the leakage inductance of the transformer is used as resonant inductance, that is, any resonant inductance involved in the above embodiments may be integrated into the leakage inductance of the transformer to which the resonant inductance corresponds. When the leakage inductance of the transformer is appropriate, the leakage inductance functions as inductance, and at this time, there is no need to set up independent resonant inductance in a circuit.

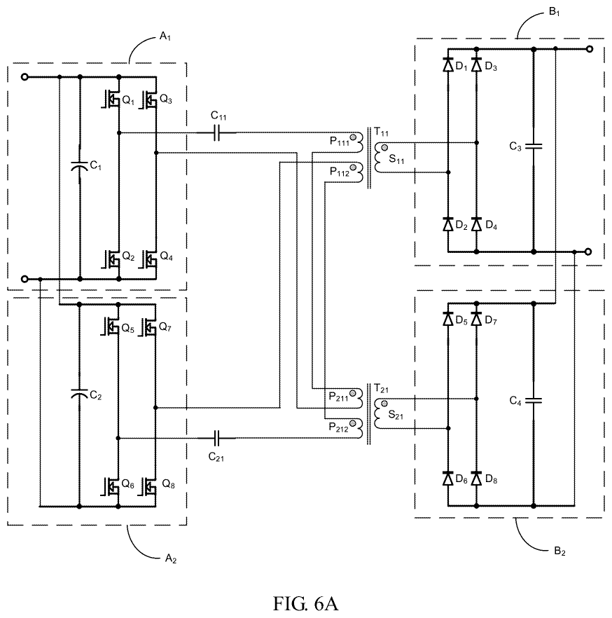

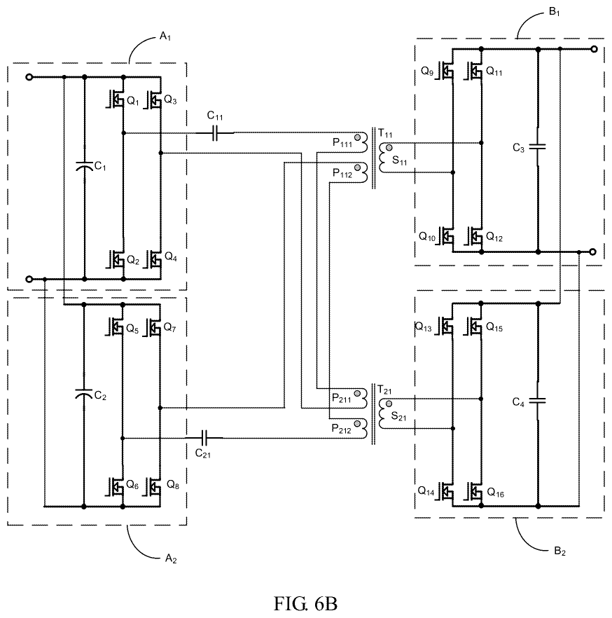

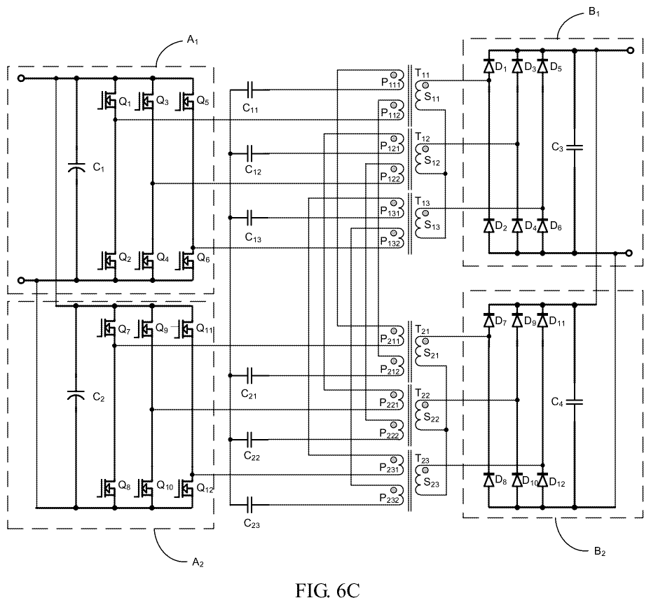

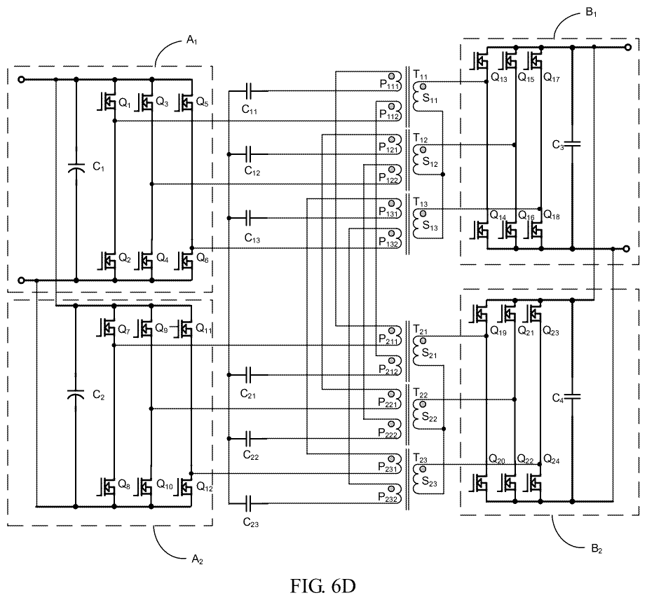

Specifically, as described above, the transformer used in this disclosure includes two primary windings and one secondary winding, the secondary winding being arranged between the two primary windings, so that the two primary windings are relatively far from each other, thereby resulting in a relatively low coupling coefficient therebetween. It can be seem from a definition of the coupling coefficient that when the coupling coefficient is relatively low, it means that the leakage inductance of the transformer is relatively large. Therefore, in this embodiment, in order to further simplify a circuit, the leakage inductance of the transformer is adjusted to be in an appropriate size to replace the resonant inductance in the circuit and achieve integration of resonant inductance. When the leakage inductance of the transformer is not large enough, inductance may be connected in series outside the transformer at the same time, and the inductance and the leakage inductance of the transformer connected in series jointly serve as resonant inductance, and reference may be made to FIGS. 6A-6D for details. FIG. 6A is a topological graph of the circuit shown in FIG. 4C after leakage inductance integration, FIG. 6B is a topological graph of the circuit shown in FIG. 4D after leakage inductance integration, FIG. 6C is a topological graph of the circuit shown in FIG. 5C after leakage inductance integration, and FIG. 6D is a topological graph of the circuit shown in FIG. 5D after leakage inductance integration.

In some embodiments, this disclosure further provides a current equalization system, which adopts any multi-transformer DCDC circuit provided in this disclosure. Other circuit structures of the current equalization system may vary as demanded, and are not specifically limited in this disclosure.

With very simple synchronization control techniques, on the premise of realizing the function of power parallel, power equalization, i.e. natural current equalization, between two power units, is simultaneously realized in the multi-transformer DCDC circuit and the current equalization system in this disclosure naturally, control schemes are simplified, and reliabilities of circuits are improved.

The purpose, technical solutions and advantages of this disclosure are described in the above embodiments. It should be noted that the above description is only embodiments of this disclosure, and is not intended to limit the protection scope of this disclosure. Any modifications, equivalent substitutions, improvements, etc. made within the principles of this disclosure shall be included in the protection scope of this disclosure.

1. A multi-transformer DCDC circuit, comprising two LLC circuits, each LLC circuit including a primary circuit, a secondary circuit and m transformers,
each of the transformers including two primary windings and a secondary winding arranged between the two primary windings;
wherein the two LLC circuits comprise a first LLC circuit and a second LLC circuit, a first primary winding of an i-th transformer of the first LLC circuit being connected in series with a first primary winding of an i-th transformer of the second LLC circuit and then connected to a corresponding primary circuit, a second primary winding of the i-th transformer of the first LLC circuit being connected in series with a second primary winding of an i-th transformer of the second LLC circuit and then connected to a corresponding primary circuit, and the secondary windings of the transformers are connected to corresponding secondary circuits; where, 1≤i≤m, and both i and m are positive integers.

2. The multi-transformer DCDC circuit according to claim 1, wherein the primary circuit comprises a full-bridge circuit, and a value of m is 1;
wherein the primary circuit of the first LLC circuit comprises a first switching tube, a second switching tube, a third switching tube and a fourth switching tube, the first switching tube and the second switching tube being connected in series and then connected in parallel with the third switching tube and the fourth switching tube that are connected in series, the primary circuit of the second LLC circuit comprises a fifth switching tube, a sixth switching tube, a seventh switching tube and an eighth switching tube, the fifth switching tube and the sixth switching tube being connected in series and then connected in parallel with the seventh switching tube and the eighth switching tube that are connected in series;
a first primary winding of a transformer of the first LLC circuit is connected in series with a set of resonant capacitors and resonant inductors and then connected between the first switching tube and the second switching tube, and a first primary winding of a transformer of the second LLC circuit is connected between the third switching tube and the fourth switching tube;
a second primary winding of the transformer of the first LLC circuit is connected between the seventh switching tube and the eighth switching tube, and a second primary winding of the transformer of the second LLC circuit is connected in series with a set of resonant capacitors and resonant inductors and then connected between the fifth switching tube and sixth switching tube.

3. The multi-transformer DCDC circuit according to claim 2, wherein the secondary circuit comprises a full wave rectifier circuit;
the secondary circuit of the first LLC circuit comprises a first diode, a second diode, a third diode and a fourth diode, the first diode and the second diode being connected in series and then connected in parallel with the third diode and the fourth diode that are connected in series, the secondary circuit of the second LLC circuit comprises a fifth diode, a sixth diode, a seventh diode and an eighth diode, the fifth diode and the sixth diode being connected in series and then connected in parallel with the seventh diode and the eighth that are connected in series;
one end of the secondary winding of the transformer of the first LLC circuit is connected between the first diode and the second diode, and the other end thereof is connected between the third diode and the fourth diode;
one end of the secondary winding of the transformer of the second LLC circuit is connected between the fifth diode and the sixth diode, and the other end thereof is connected between the seventh diode and the eighth diode.

4. The multi-transformer DCDC circuit according to claim 2, wherein the secondary circuit comprises a synchronous rectifier circuit;
the secondary circuit of the first LLC circuit comprises a ninth switching tube, a tenth switching tube, an eleventh switching tube and a twelfth switching tube, the ninth switching tube and the tenth switching tube being connected in series and then connected in parallel with the eleventh switching tube and the twelfth switching tube that are connected in series, the secondary circuit of the second LLC circuit comprises a thirteenth switching tube, a fourteenth switching tube, a fifteenth switching tube and a sixteenth switching tube, the thirteenth switching tube and the fourteenth switching tube being connected in series and then connected in parallel with the fifteenth switching tube and the sixteenth switching tube that are connected in series;
one end of the secondary winding of the transformer of the first LLC circuit is connected between the ninth switching tube and the tenth switching tube, and the other end thereof is connected between the eleventh switching tube and the twelfth switching tube;
one end of the secondary winding of the transformer of the second LLC circuit is connected between the thirteenth switching tube and the fourteenth switching tube, and the other end thereof is connected between the fifteenth switching tube and the sixteenth switching tube.

5. The multi-transformer DCDC circuit according to claim 1, wherein the primary circuit comprises a three-phase bridge circuit, and a value of m is 3;
wherein the primary circuit of the first LLC circuit comprises a first switching tube, a second switching tube, a third switching tube, a fourth switching tube, a fifth switching tube and a sixth switching tube, the first switching tube and the second switching tube being connected in series and then respectively connected in parallel with the third switching tube and the fourth switching tube that are connected in series and the fifth switching tube and the sixth switching tube that are connected in series;
the primary circuit of the second LLC circuit comprises a seventh switching tube, an eighth switching tube, a ninth switching tube, a tenth switching tube, an eleventh switching tube and a twelfth switching tube, the seventh switching tube and the eighth switching tube being connected in series and then respectively connected in parallel with the ninth switching tube and the tenth switching tube that are connected in series and the eleventh switching tube and the twelfth switching tube that are connected in series;
the second primary winding of the first transformer of the first LLC circuit is connected between the first switching tube and the second switching tube, the first primary winding of the first transformer of the second LLC circuit is connected between the seventh switching tube and the eighth switching tube, and the first primary winding of the first transformer of the first LLC circuit is connected in series with a set of resonant capacitors and resonant inductors, and then connected to the second primary winding of the first transformer of the second LLC circuit via another set of resonant capacitors and resonant inductors;
a second primary winding of a second transformer of the first LLC circuit is connected between the third switching tube and the fourth switching tube, a first primary winding of the second transformer of the second LLC circuit is connected between the ninth switching tube and the tenth switching tube, and the first primary winding of the second transformer of the first LLC circuit is connected in series with a set of resonant capacitors and resonant inductors, and then connected to the second primary winding of the second transformer of the second LLC circuit via another set of resonant capacitors and resonant inductors;
a second primary winding of a third transformer of the first LLC circuit is connected between the fifth switching tube and sixth switching tube, a first primary winding of the third transformer of the second LLC circuit is connected between the eleventh switching tube and the twelfth switching tube, and the first primary winding of the third transformer of the first LLC circuit is connected in series with a set of resonant capacitors and resonant inductors, and then connected to the second primary winding of the third transformer of the second LLC circuit via another set of resonant capacitors and resonant inductors.

6. The multi-transformer DCDC circuit according to claim 5, wherein the secondary circuit comprises a full wave rectifier circuit;
the secondary circuit of the first LLC circuit comprises a first diode, a second diode, a third diode, a fourth diode, a fifth diode and a sixth diode, the first diode and the second diode being connected in series and then respective connected in parallel with the third diode and the fourth diode that are connected in series and the fifth diode and the sixth diode that are connected in series, the secondary circuit of the second LLC circuit comprises a seven diode, an eighth diode, a ninth diode, a tenth diode, an eleventh diode and a twelfth diode, the seven diode and the eighth diode being connected in series and then respective connected in parallel with the ninth diode and the tenth diode that are connected in series and the eleventh diode and the twelfth diode that are connected in series;
a first end of the secondary winding of the first transformer of the first LLC circuit is connected between the first diode and the second diode, a first end of the secondary winding of the second transformer of the first LLC circuit is connected between the third diode and the fourth diode, a first end of the secondary winding of the third transformer of the first LLC circuit is connected between the fifth diode and the sixth diode, a second end of the secondary winding of the first transformer of the first LLC circuit is connected to a second end of the secondary winding of the second transformer of the first LLC circuit and a second end of the secondary winding of the third transformer of the first LLC circuit;
a first end of the secondary winding of the first transformer of the second LLC circuit is connected between the seventh diode and the eighth diode, a first end of the secondary winding of the second transformer of the second LLC circuit is connected between the ninth diode and the tenth diode, a first end of the secondary winding of the third transformer of the second LLC circuit is connected between the eleventh diode and the twelfth diode, a second end of the secondary winding of the first transformer of the second LLC circuit is connected to a second end of the secondary winding of the second transformer of the second LLC circuit and a second end of the secondary winding of the third transformer of the second LLC circuit.

7. The multi-transformer DCDC circuit according to claim 5, wherein the secondary circuit comprises a synchronous rectifier circuit;
the secondary circuit of the first LLC circuit comprises a thirteenth switching tube, a fourteenth switching tube, a fifteenth switching tube, a sixteenth switching tube, a seventeenth switching tube and an eighteenth switching tube, the thirteenth switching tube and the fourteenth switching tube being connected in series and then respectively connected in parallel with the fifteenth switching tube and the sixteenth switching tube that are connected in series and the seventeenth switching tube and the eighteenth switching tube that are connected in series, and the secondary circuit of the second LLC circuit comprises a nineteenth switching tube, a twentieth switching tube, a twenty-first switching tube, a twenty-second switching tube, a twenty-third switching tube and a twenty fourth switching tube, the nineteenth switching tube and the twentieth switching tube being connected in series and then respectively connected in parallel with the twenty-first switching tube and the twenty-second switching tube that are connected in series and the twenty-third switching tube and the twenty-fourth switching tube that are connected in series;
the first end of the secondary winding of the first transformer of the first LLC circuit is connected between the thirteenth switching tube and fourteenth switching tube, the first end of the secondary winding of the second transformer of the first LLC circuit is connected between the fifteenth switching tube and sixteenth switching tube, the first end of the secondary winding of the third transformer of the first LLC circuit is connected between the seventeenth switching tube and eighteenth switching tube, the second end of the secondary winding of the first transformer of the first LLC circuit is connected to the second end of the secondary winding of the second transformer of the first LLC circuit and the second end of the secondary winding of the third transformer of the first LLC circuit;
the first end of the secondary winding of the first transformer of the second LLC circuit is connected between the nineteenth switching tube and the twentieth switching tube, the first end of the secondary winding of the second transformer of the second LLC circuit is connected between the twenty-first switching tube and the twenty-second switching tube, the first end of the secondary winding of the third transformer of the second LLC circuit is connected between the twenty-third switching tube and twenty-fourth switching tube, and the second end of the secondary winding of the first transformer of the second LLC circuit is connected to the second end of the secondary winding of the second transformer of the second LLC circuit and the second end of the secondary winding of the third transformer of the second LLC circuit.

8. The multi-transformer DCDC circuit according to claim 2, wherein any resonant inductor in the multi-transformer DCDC circuit is integrated into leakage inductance of a transformer to which the resonant inductor corresponds.

9. The multi-transformer DCDC circuit according to claim 1, wherein the primary circuit of the first LLC circuit is connected in parallel with the primary circuit of the second LLC circuit.

10. The multi-transformer DCDC circuit according to claim 1, wherein the primary circuit of the first LLC circuit is connected in series with the primary circuit of the second LLC circuit.

11. A current equalization system, comprising a multi-transformer DCDC circuit,
the multi-transformer DCDC circuit comprises two LLC circuits, each LLC circuit including a primary circuit, a secondary circuit and m transformers,
each of the transformers including two primary windings and a secondary winding arranged between the two primary windings;
wherein the two LLC circuits comprise a first LLC circuit and a second LLC circuit, a first primary winding of an i-th transformer of the first LLC circuit being connected in series with a first primary winding of an i-th transformer of the second LLC circuit and then connected to a corresponding primary circuit, a second primary winding of the i-th transformer of the first LLC circuit being connected in series with a second primary winding of an i-th transformer of the second LLC circuit and then connected to a corresponding primary circuit, and the secondary windings of the transformers are connected to corresponding secondary circuits; where, 1≤i≤m, and both i and m are positive integers.

12. The current equalization system according to claim 11, wherein the primary circuit comprises a full-bridge circuit, and a value of m is 1;
wherein the primary circuit of the first LLC circuit comprises a first switching tube, a second switching tube, a third switching tube and a fourth switching tube, the first switching tube and the second switching tube being connected in series and then connected in parallel with the third switching tube and the fourth switching tube that are connected in series, the primary circuit of the second LLC circuit comprises a fifth switching tube, a sixth switching tube, a seventh switching tube and an eighth switching tube, the fifth switching tube and the sixth switching tube being connected in series and then connected in parallel with the seventh switching tube and the eighth switching tube that are connected in series;
a first primary winding of a transformer of the first LLC circuit is connected in series with a set of resonant capacitors and resonant inductors and then connected between the first switching tube and the second switching tube, and a first primary winding of a transformer of the second LLC circuit is connected between the third switching tube and the fourth switching tube;
a second primary winding of the transformer of the first LLC circuit is connected between the seventh switching tube and the eighth switching tube, and a second primary winding of the transformer of the second LLC circuit is connected in series with a set of resonant capacitors and resonant inductors and then connected between the fifth switching tube and sixth switching tube.

13. The current equalization system according to claim 12, wherein the secondary circuit comprises a full wave rectifier circuit;
the secondary circuit of the first LLC circuit comprises a first diode, a second diode, a third diode and a fourth diode, the first diode and the second diode being connected in series and then connected in parallel with the third diode and the fourth diode that are connected in series, the secondary circuit of the second LLC circuit comprises a fifth diode, a sixth diode, a seventh diode and an eighth diode, the fifth diode and the sixth diode being connected in series and then connected in parallel with the seventh diode and the eighth that are connected in series;
one end of the secondary winding of the transformer of the first LLC circuit is connected between the first diode and the second diode, and the other end thereof is connected between the third diode and the fourth diode;
one end of the secondary winding of the transformer of the second LLC circuit is connected between the fifth diode and the sixth diode, and the other end thereof is connected between the seventh diode and the eighth diode.

14. The current equalization system according to claim 12, wherein the secondary circuit comprises a synchronous rectifier circuit;
the secondary circuit of the first LLC circuit comprises a ninth switching tube, a tenth switching tube, an eleventh switching tube and a twelfth switching tube, the ninth switching tube and the tenth switching tube being connected in series and then connected in parallel with the eleventh switching tube and the twelfth switching tube that are connected in series, the secondary circuit of the second LLC circuit comprises a thirteenth switching tube, a fourteenth switching tube, a fifteenth switching tube and a sixteenth switching tube, the thirteenth switching tube and the fourteenth switching tube being connected in series and then connected in parallel with the fifteenth switching tube and the sixteenth switching tube that are connected in series;
one end of the secondary winding of the transformer of the first LLC circuit is connected between the ninth switching tube and the tenth switching tube, and the other end thereof is connected between the eleventh switching tube and the twelfth switching tube;
one end of the secondary winding of the transformer of the second LLC circuit is connected between the thirteenth switching tube and the fourteenth switching tube, and the other end thereof is connected between the fifteenth switching tube and the sixteenth switching tube.

15. The current equalization system according to claim 11, wherein the primary circuit comprises a three-phase bridge circuit, and a value of m is 3;
wherein the primary circuit of the first LLC circuit comprises a first switching tube, a second switching tube, a third switching tube, a fourth switching tube, a fifth switching tube and a sixth switching tube, the first switching tube and the second switching tube being connected in series and then respectively connected in parallel with the third switching tube and the fourth switching tube that are connected in series and the fifth switching tube and the sixth switching tube that are connected in series;
the primary circuit of the second LLC circuit comprises a seventh switching tube, an eighth switching tube, a ninth switching tube, a tenth switching tube, an eleventh switching tube and a twelfth switching tube, the seventh switching tube and the eighth switching tube being connected in series and then respectively connected in parallel with the ninth switching tube and the tenth switching tube that are connected in series and the eleventh switching tube and the twelfth switching tube that are connected in series;
the second primary winding of the first transformer of the first LLC circuit is connected between the first switching tube and the second switching tube, the first primary winding of the first transformer of the second LLC circuit is connected between the seventh switching tube and the eighth switching tube, and the first primary winding of the first transformer of the first LLC circuit is connected in series with a set of resonant capacitors and resonant inductors, and then connected to the second primary winding of the first transformer of the second LLC circuit via another set of resonant capacitors and resonant inductors;
a second primary winding of a second transformer of the first LLC circuit is connected between the third switching tube and the fourth switching tube, a first primary winding of the second transformer of the second LLC circuit is connected between the ninth switching tube and the tenth switching tube, and the first primary winding of the second transformer of the first LLC circuit is connected in series with a set of resonant capacitors and resonant inductors, and then connected to the second primary winding of the second transformer of the second LLC circuit via another set of resonant capacitors and resonant inductors;
a second primary winding of a third transformer of the first LLC circuit is connected between the fifth switching tube and sixth switching tube, a first primary winding of the third transformer of the second LLC circuit is connected between the eleventh switching tube and the twelfth switching tube, and the first primary winding of the third transformer of the first LLC circuit is connected in series with a set of resonant capacitors and resonant inductors, and then connected to the second primary winding of the third transformer of the second LLC circuit via another set of resonant capacitors and resonant inductors.

16. The current equalization system according to claim 15, wherein the secondary circuit comprises a full wave rectifier circuit;
the secondary circuit of the first LLC circuit comprises a first diode, a second diode, a third diode, a fourth diode, a fifth diode and a sixth diode, the first diode and the second diode being connected in series and then respective connected in parallel with the third diode and the fourth diode that are connected in series and the fifth diode and the sixth diode that are connected in series, the secondary circuit of the second LLC circuit comprises a seven diode, an eighth diode, a ninth diode, a tenth diode, an eleventh diode and a twelfth diode, the seven diode and the eighth diode being connected in series and then respective connected in parallel with the ninth diode and the tenth diode that are connected in series and the eleventh diode and the twelfth diode that are connected in series;
a first end of the secondary winding of the first transformer of the first LLC circuit is connected between the first diode and the second diode, a first end of the secondary winding of the second transformer of the first LLC circuit is connected between the third diode and the fourth diode, a first end of the secondary winding of the third transformer of the first LLC circuit is connected between the fifth diode and the sixth diode, a second end of the secondary winding of the first transformer of the first LLC circuit is connected to a second end of the secondary winding of the second transformer of the first LLC circuit and a second end of the secondary winding of the third transformer of the first LLC circuit;
a first end of the secondary winding of the first transformer of the second LLC circuit is connected between the seventh diode and the eighth diode, a first end of the secondary winding of the second transformer of the second LLC circuit is connected between the ninth diode and the tenth diode, a first end of the secondary winding of the third transformer of the second LLC circuit is connected between the eleventh diode and the twelfth diode, a second end of the secondary winding of the first transformer of the second LLC circuit is connected to a second end of the secondary winding of the second transformer of the second LLC circuit and a second end of the secondary winding of the third transformer of the second LLC circuit.

17. The current equalization system according to claim 15, wherein the secondary circuit comprises a synchronous rectifier circuit;
the secondary circuit of the first LLC circuit comprises a thirteenth switching tube, a fourteenth switching tube, a fifteenth switching tube, a sixteenth switching tube, a seventeenth switching tube and an eighteenth switching tube, the thirteenth switching tube and the fourteenth switching tube being connected in series and then respectively connected in parallel with the fifteenth switching tube and the sixteenth switching tube that are connected in series and the seventeenth switching tube and the eighteenth switching tube that are connected in series, and the secondary circuit of the second LLC circuit comprises a nineteenth switching tube, a twentieth switching tube, a twenty-first switching tube, a twenty-second switching tube, a twenty-third switching tube and a twenty fourth switching tube, the nineteenth switching tube and the twentieth switching tube being connected in series and then respectively connected in parallel with the twenty-first switching tube and the twenty-second switching tube that are connected in series and the twenty-third switching tube and the twenty-fourth switching tube that are connected in series;
the first end of the secondary winding of the first transformer of the first LLC circuit is connected between the thirteenth switching tube and fourteenth switching tube, the first end of the secondary winding of the second transformer of the first LLC circuit is connected between the fifteenth switching tube and sixteenth switching tube, the first end of the secondary winding of the third transformer of the first LLC circuit is connected between the seventeenth switching tube and eighteenth switching tube, the second end of the secondary winding of the first transformer of the first LLC circuit is connected to the second end of the secondary winding of the second transformer of the first LLC circuit and the second end of the secondary winding of the third transformer of the first LLC circuit;
the first end of the secondary winding of the first transformer of the second LLC circuit is connected between the nineteenth switching tube and the twentieth switching tube, the first end of the secondary winding of the second transformer of the second LLC circuit is connected between the twenty-first switching tube and the twenty-second switching tube, the first end of the secondary winding of the third transformer of the second LLC circuit is connected between the twenty-third switching tube and twenty-fourth switching tube, and the second end of the secondary winding of the first transformer of the second LLC circuit is connected to the second end of the secondary winding of the second transformer of the second LLC circuit and the second end of the secondary winding of the third transformer of the second LLC circuit.

18. The current equalization system according to claim 12, wherein any resonant inductor in the multi-transformer DCDC circuit is integrated into leakage inductance of a transformer to which the resonant inductor corresponds.

19. The current equalization system according to claim 11, wherein the primary circuit of the first LLC circuit is connected in parallel with the primary circuit of the second LLC circuit.

20. The current equalization system according to claim 11, wherein the primary circuit of the first LLC circuit is connected in series with the primary circuit of the second LLC circuit.
